(19) United States
(12) Patent Application Publication
(10) Pub. No.: US 2010/0030732 A1
(43) Pub. Date: Feb. 4, 2010

(54) SYSTEM AND METHOD TO CREATE PROCESS REFERENCE MAPS FROM LINKS DESCRIBED IN A BUSINESS PROCESS MODEL

(75) Inventors: Thomas Gschwind, Zurich (CH); Jana Koehler, Oberrieden (CH)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 12/183,593

(22) Filed: Jul. 31, 2008

(51) Int. Cl. G06F 17/30; G06F 7/06

(52) U.S. Cl. 707/2

(57) ABSTRACT

A method of constructing a process reference map. The method includes iterating over each of a plurality of process models. An intermediary reference graph is created. A directed link for each reference in the process models is added to the intermediary reference graph, the link pointing from a node in the reference graph representing a process model within which a reference occurred to a node representing a process model that the reference is pointing towards. The method determines, between two process models of the plurality of process models, whether an inconsistency including one of an outbound process reference missing inconsistency, an inbound process reference missing inconsistency, and an unavailable information inconsistency exists. A new process model map is created from the intermediary reference graph with one element each representing a process models and the elements being linked representing the references therebetween. Each link comprises an attribute indicating one of a context, type of reference, and a modeling element.

### BACKGROUND OF THE INVENTION

1. Field of the Invention

The present invention generally relates to a method and apparatus for creating a new process model from related business process models and optionally checking whether the references between them are consistent.

2. Description of the Related Art

Business process models can contain references to other process models. A reference is a mechanism for connecting the end, or the result, of one process to the start of or to trigger another process model. The reference may be described as a “goto” programming statement. Typically, there are two references to represent this construct, one indicating in the source process model that this process continues within another process model and one indicating in the target process model where to continue the execution of which source process model. Such references can also be referred to as “process interfaces” (such as in ARIS program by IDS Scheer) or link (such as in business process modeling notation (BPMN)).

For example, in a typical event-driven process chains modeling approach that is used in the ARIS tool set. FIG. 1 illustrates one such related art business process model 100. Referring to FIG. 1, related art business process model 100 includes inbound process interface 110 at the beginning and outbound process interface 180 at the end of the control flow. Throughout the process of business process model 100, different steps, including decision step 130, step one 120, step two 140, step three 150, step four 160, and step five 170 may be implemented and executed. The various steps may include any known, foreseeable, or related business decision steps.

Process references, process interfaces, or links, that occur at the beginning of the control flow in business model 100 are inbound links (or references) and those that occur at the end of the control flow are outbound links (or references).

Other related business process models may also include one or more links in the intermediate steps. For example, decision step 130 may include a process interface or link associated with another business process model.

Conventionally, business users would not have an overview on how their business processes connect to each other where those business processes are complex. Without such an overview, users cannot revise the connections of their processes. For technical users, such an overview is also helpful because they can see whether the current process models are a suitable basis for a service-oriented architecture.

### SUMMARY OF THE INVENTION

In view of the foregoing, and other exemplary problems, drawbacks, and disadvantages of the conventional systems, it is an exemplary feature of the present invention to provide a method and system (e.g. a computerized method) of constructing a process reference map.

In an exemplary aspect, the method includes iterating over each of a plurality of process models, creating an intermediary reference graph, adding a directed link for each reference in the process models to the intermediary reference graph, the link pointing from a node in the reference graph representing a process model within which a reference occurred to a node representing a process model that the reference is pointing towards, determining whether, between two process models of the plurality of process models, that an inconsistency including one of an outbound process reference missing inconsistency, an inbound process reference missing inconsistency, or if some information is not available inconsistency exists, and constructing a new process model map from the intermediary reference graph with one element each representing a process models and the elements being linked representing the references therebetween. Each link has an attribute indicating one of a context, type of reference, or a modeling element.

For example, in an exemplary aspect of the invention, a business process model where the user has defined references is taken and a reference map is generated by processing the information contained in the references. The invention could be used on its own or, for instance, in context of the ARIS import for WebSphere Business Modeler. ARIS business process models contain process interfaces, that is, references, and upon the import into Modeler, the map can be generated. The present invention may also be used in combination with process modeling tools using the BPMN notation and generating such a map for the BPMN links contained within the process models.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 illustrates an exemplary business process model 100 used to explain the present invention;

FIG. 2 illustrates exemplary system process models A and B;

FIG. 3 illustrates an exemplary internal graph 300;

FIG. 4 illustrates a resulting reference map 400;

FIG. 5 exemplarily illustrates a set of inconsistent process model C and process model D;

FIG. 6 exemplarily illustrates generated internal graph 600;

FIG. 7 exemplarily illustrates resulting reference map 700;

FIG. 8 illustrates exemplary method 800 for determining reference maps;

FIG. 9 exemplarily illustrates Step 840 in further detail;

FIG. 10 exemplarily illustrates method 1000 for checking the outbound edges for inconsistencies of Step 920;

FIG. 11 exemplarily illustrates the method 1100 for checking the incoming edges for inconsistencies of Step 930;

FIG. 12 illustrates a typical hardware configuration 1200 which may be used for implementing the computer system and method according to the exemplary aspects of the present invention; and

FIG. 13 illustrates a tangible storage medium (e.g., a magnetic data storage diskette 1300 or CD-ROM 1302) to store the method of the present invention.

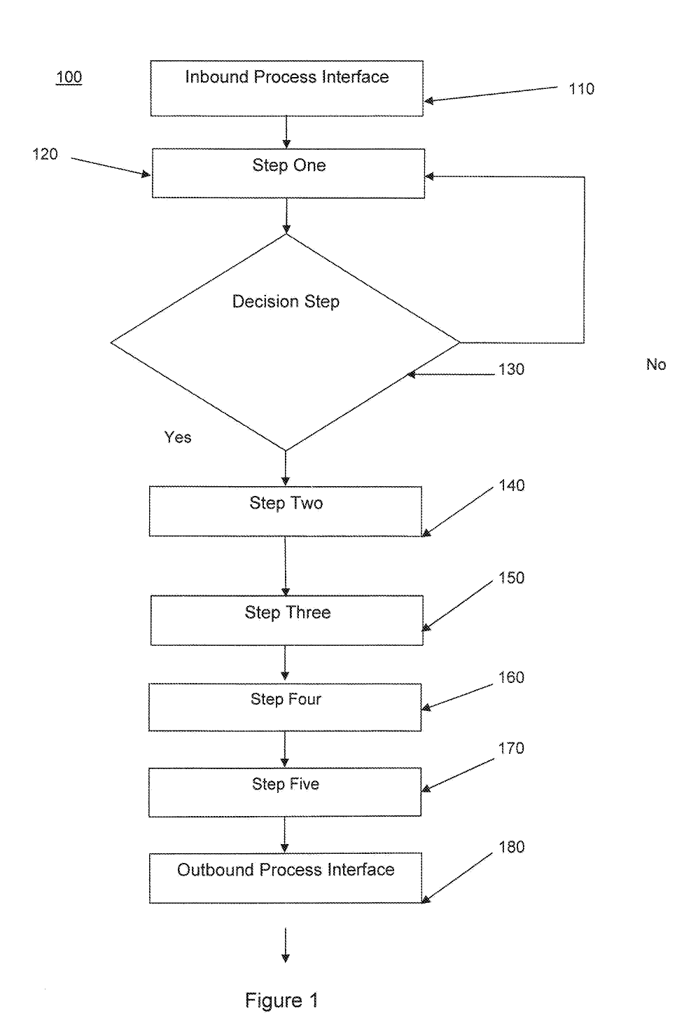

### DETAILED DESCRIPTION OF AN EXEMPLARY EMBODIMENT OF THE INVENTION

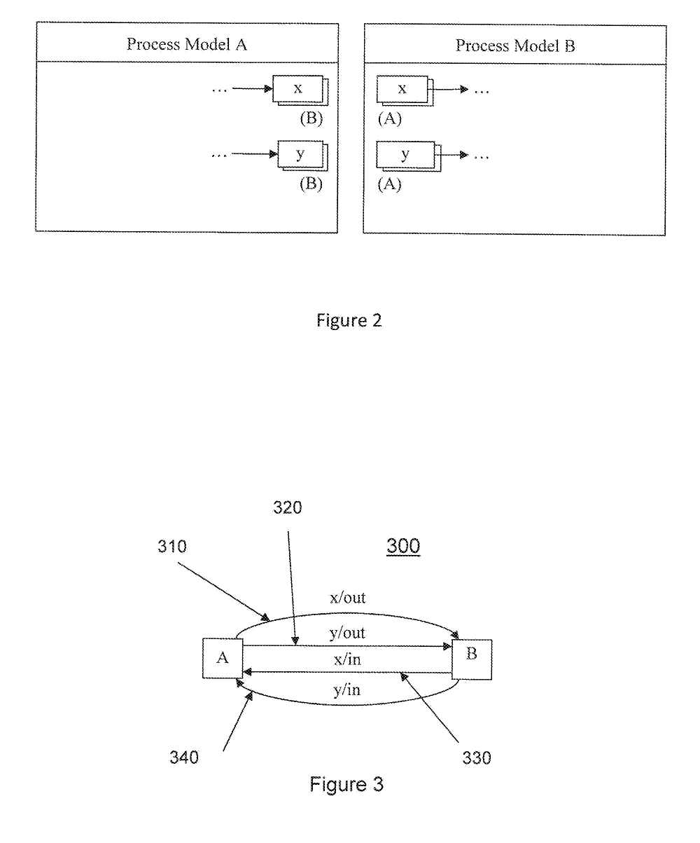

Referring now to the drawings, and more particularly to FIGS. 2-13, there are shown exemplary embodiments of the method and structures according to the present invention.

FIG. 2 illustrates exemplary process model A and process model B that may be considered by the present invention. Referring to FIG. 2, process model A and process model B each contain two references that link to another process. Thus, process model A contains reference x pointing to process model B as its interface and reference y that also points to process model B as its interface. In addition, process model B includes reference x pointing to process model A and another reference y that also points to process model A as its interface.

Exemplarily, a dependencies chart is created based on the existing process models. The dependencies chart may also be referred to as an “intermediate reference graph.” FIG. 3 illustrates an exemplary dependencies chart 300 between process models A and B of FIG. 2 as may be created by the present invention. Referring to FIG. 3, the created dependencies chart 300 contains edge 310 from process model A to process model B (since A contains a reference pointing to B). Edge 310 is marked with the name of the reference (x/out). Because edge 310 is an outgoing reference, there is an inference of the fact that edge 310 is a reference that would expect another process to start performing a process. Additionally, if the source process models are already in a suitable format, then this step may not be necessary. Where the process models already provides a similar process interface as the dependency graph, one can do the consistency checking and generate the reference maps directly from the source process models.

In the case illustrated in FIG. 3, this exemplary information is derived from the fact that the reference in process model A has no outgoing edges. Edge 310 is a reference that expects this process to be continued by another process model. FIG. 3 therefore illustrates a case in which that process model would be process model B. In this example, this information is derived from the fact that the references in process model A have no outgoing edges.

In addition, process model A also contains edge 320 from A to B since A contains a second reference pointing to B. Edge 320 has the attributes of being reference y and having an “outward” direction and therefore also marked with the name of the reference (y/out). Exemplarily, an incoming edge is an edge containing an expectation that another process occurs to reach a certain point in execution before continuing/starting.

Dependencies graph 300 also contains edge 330 from B to A (since B contains a reference pointing to A). Edge 330 is referred to with the name x/in and is an incoming edge because edge 330 would expect another process to reach a certain point in execution before continuing/starting. Finally, edge 340 is an edge pointing from B to A due to the second reference in B, and is referred to with the name y, and is otherwise referred to as y/in.

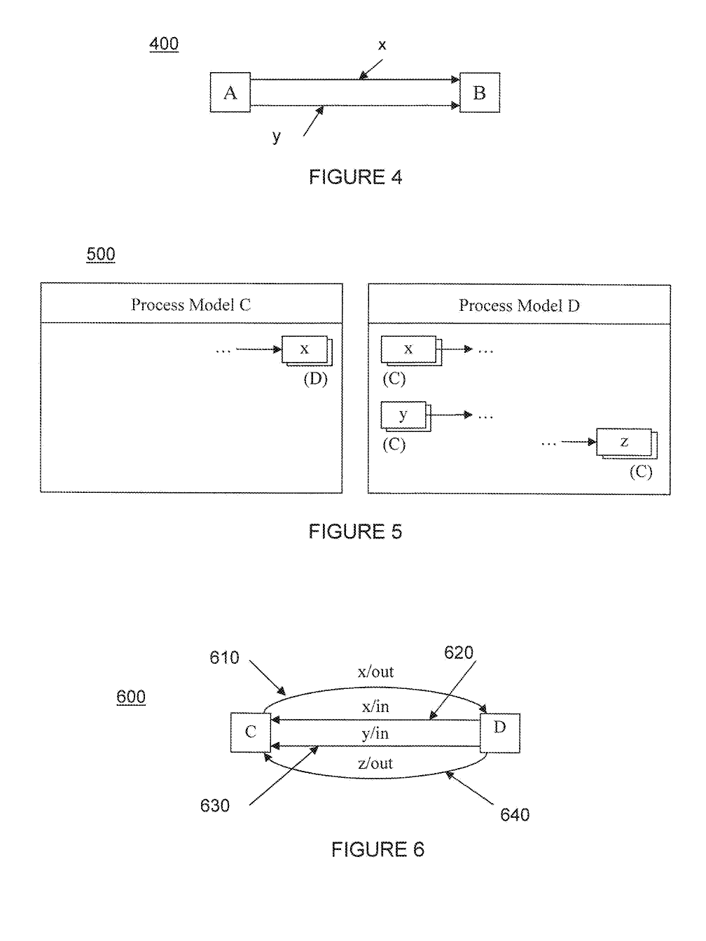

FIG. 4 illustrates process reference map 400 generated from the two input process model A and process model B according to an exemplary embodiment of the present invention. For each pair of incoming/outgoing edges 310, 320, 330, and 340 of FIG. 3 with the same name, the present invention exemplarily generates an edge from one node representing one process model to another node representing another process model. Accordingly, process reference map contains first edge x and second edge y as illustrated in FIG. 4.

In some instances, information including names of references and directionality of the references may be not available so that the references have no names or there is no information concerning an incoming or outgoing reference. Nonetheless, exemplary aspects of the present invention could account for these deficiencies to perform properly even if some of the information is not available. In some instances, such as in the analysis described below, the results would be less precise because there is less information, i.e. the process may detect an inconsistency, but the process may not be able to provide as much information about how the inconsistency occurred, such as the name of a missing reference or the type of inconsistency.

FIG. 5 exemplarily illustrates a set of inconsistent process models C and D. That is, another exemplary business process 500 includes process model C and process model D. In business process 500, process model C exemplarily contains one reference x output to D. Additionally, process model D exemplarily contains x being input to process model C, reference y being input to process model C, and reference z being output from process model C. Analysis according to an exemplary process will show that a link is missing for uni-directional reference y and uni-directional reference z.

FIG. 6 exemplarily illustrates generated internal graph 600 based on business process 500. Exemplarily, analysis by the present invention would show that links are missing for reference y being input to process model D and reference z being input to process model D from process model C. That is, there is no reciprocity for references y and z. Therefore, generated internal graph 600 reveals that edge 610 is an x/out, edge 620 is an x/in, edge 630 is a y/in, and edge 640 is a z/out.

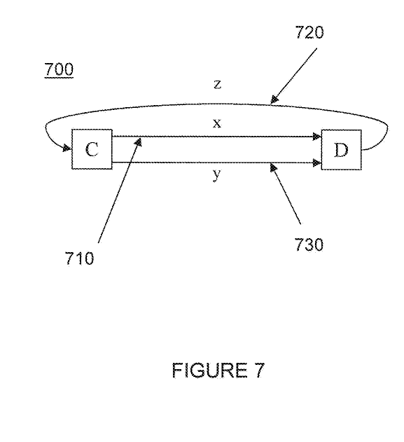

FIG. 7 exemplarily illustrates resulting reference map 700 from internal graph 600 which illustrates all edge x 710, edge y 720, and edge z 730 occurring as a result of analyzing the references 510, 520, 530, and 540 of FIG. 5. That is, similar to FIG. 4, reference map 700 includes edge x 710, edge y 720, and edge z 730. However, unlike generated process map 400 of FIG. 4, the resulting reference map 700 of FIG. 7 also illustrates links for references where the reciprocal reference is missing. These inconsistencies may be highlighted by using different annotations or colors for the links in the reference map and/or simply by creating an extra report.

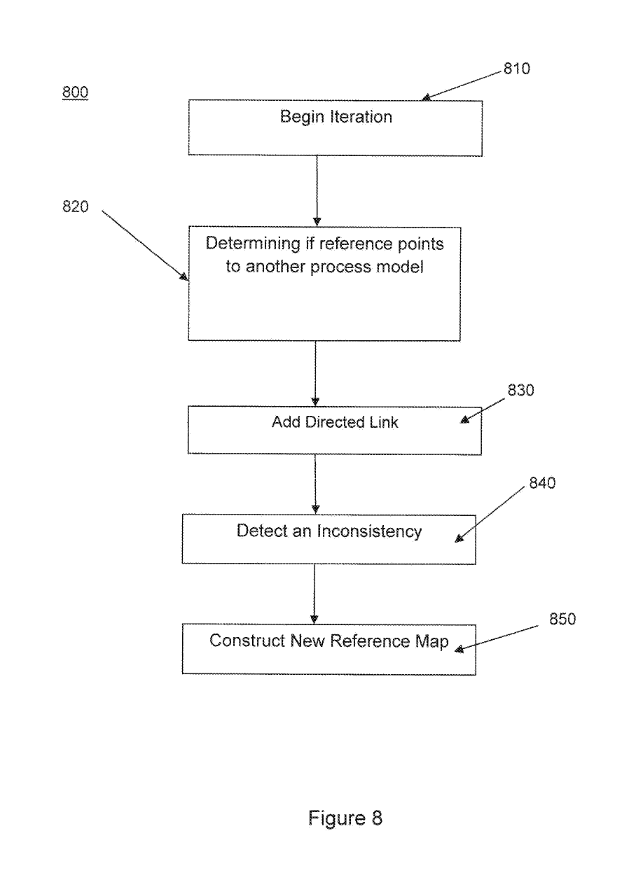

FIG. 8 illustrates an exemplary method 800 for determining reference maps. Referring to FIG. 8, Step 810 of method 800 includes beginning an iterative process of analyzing process models in a business process.

In Step 820, it is determined if a reference points to another process model and, if so, proceeding to Step 830. In Step 830, a directed link is added for each reference of the process reference map that points to another process model, the link pointing from a node representing a process model from which a reference occurred to a node representing a process model that the reference is pointed towards.

Step 840 detects an inconsistency, such as the exemplary inconsistency illustrated in FIGS. 5-7.

In Step 850, a new reference map is constructed based on associated process model links. After Step 850, method 800 may repeat and return to Step 820 when there are more references that have not been processed.

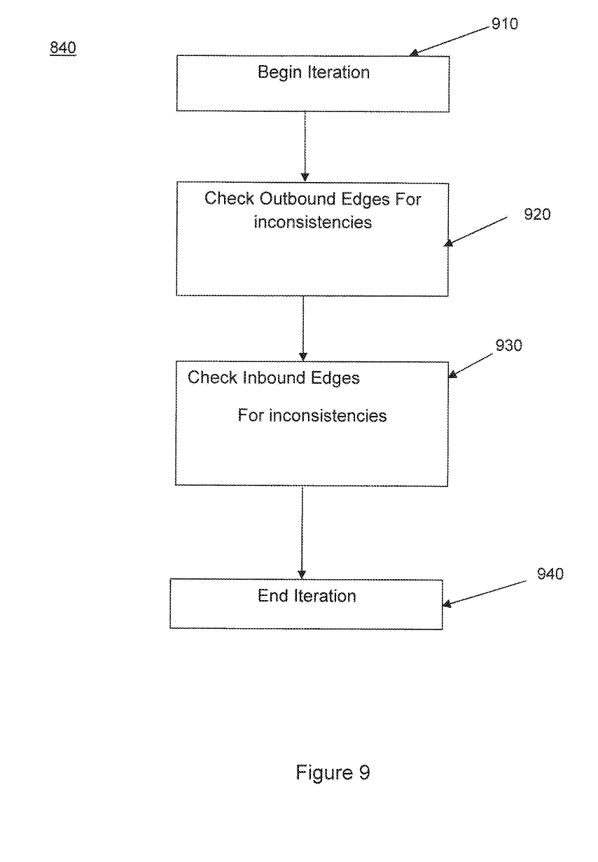

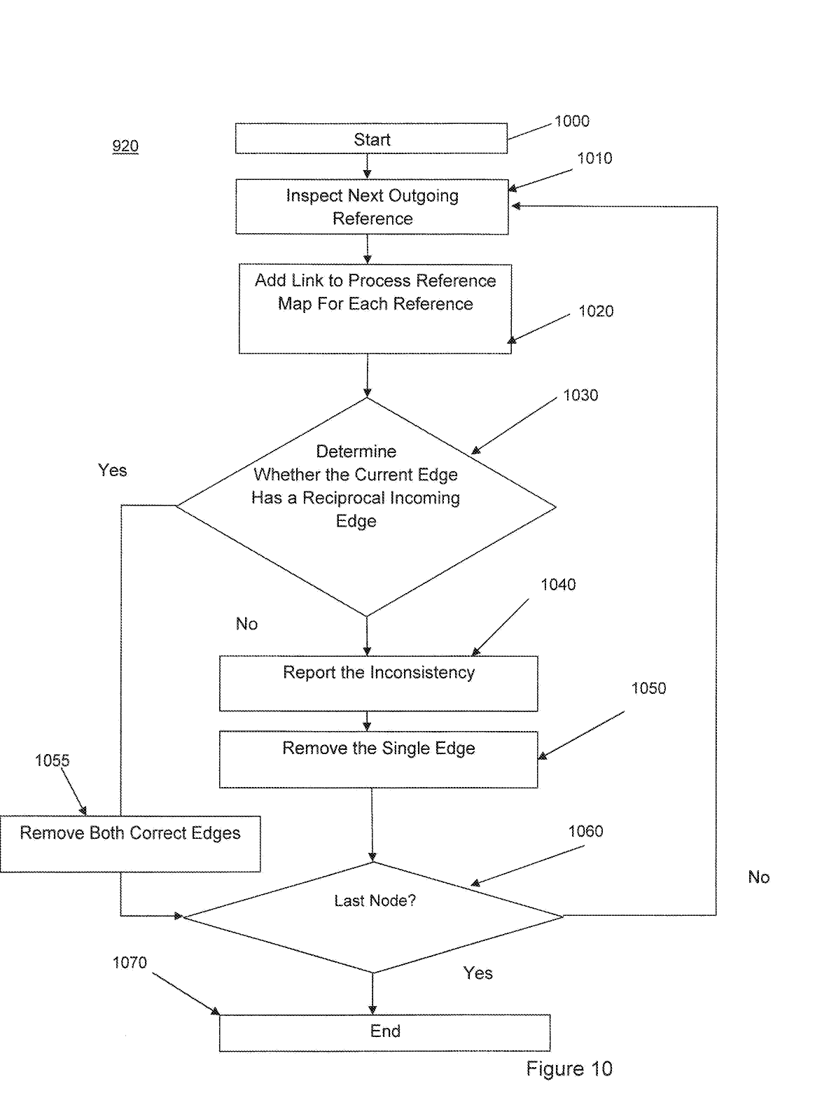

FIG. 9 exemplarily illustrates Step 840. Referring to FIG. 9, Step 840 is for detecting inconsistencies, as illustrated. The iterative method begins at Step 910. Then, Step 920 begins checking the outbound edges for inconsistencies. FIG. 10 exemplarily illustrates the method for checking the edges representing outbound references for inconsistencies of Step 920. Referring to FIG. 10, the method starts at Step 1000.

Each node would exemplarily be inspected for inconsistencies and at Step 1010; the next node is referred to for inspection. In Step 1020, a link for each reference is added to the process reference map. This process is repeated for each edge that represents an outbound reference.

In Step 1030, it is determined whether the edge currently being considered has an inbound reference of the same name pointing back to the node containing the outbound reference. If there is such a reciprocal edge, then the reference is error-free and the method proceeds with Step 1055 which removes the two correct edges and then proceeds to Step 1060 to determine if there are any nodes remaining to be inspected.

If, in Step 1030, it is determined that there is no reciprocal edge, then the method would proceed to Step 1040 to report the inconsistency and may then proceed to Step 1050 to remove the single edge. After performing Step 1050, the method may proceed to Step 1060 to determine if the current node is the last node. If the current node is the last node, then the method ends at Step 1070. On the other hand, if there are additional nodes remaining, the method proceeds to Step 1010 to begin inspecting the next node.

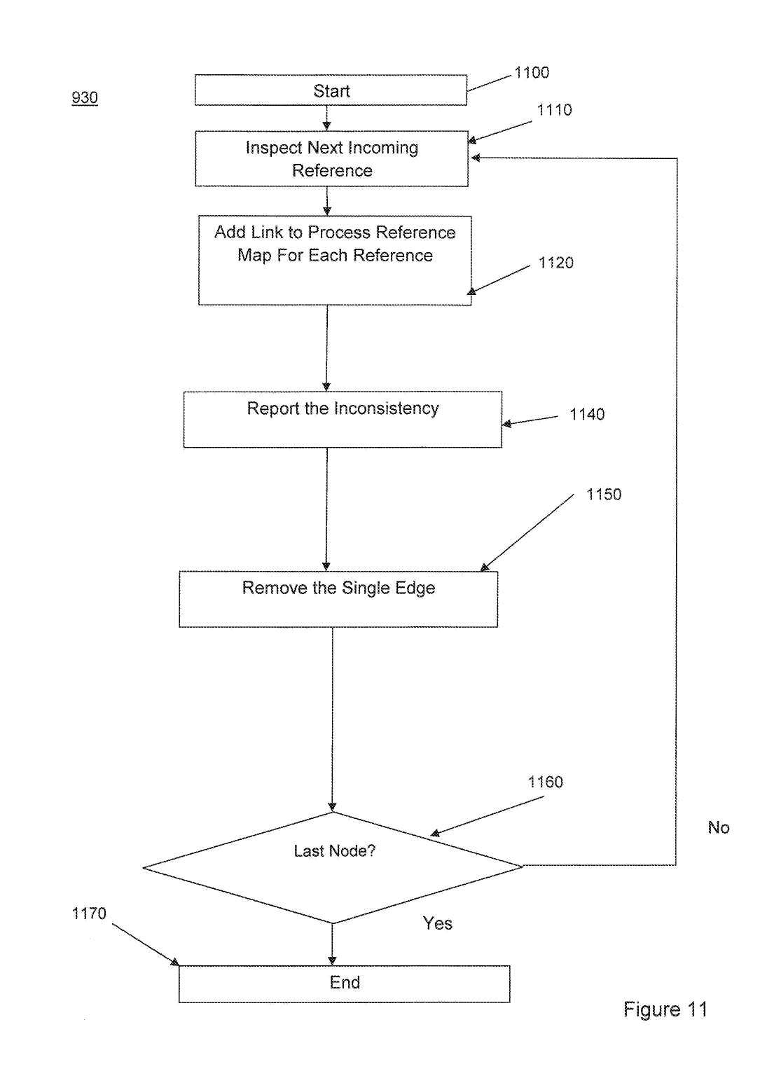

Referring back to FIG. 9, in Step 930, edges representing inbound references are checked for inconsistencies. FIG. 11 illustrates the method for checking the incoming edges for inconsistencies of Step 930. Referring to FIG. 11, the method starts at Step 1100.

Each incoming node would exemplarily be inspected for inconsistencies and at Step 1110, the next node is referred to for inspection. In Step 1120, a link for each reference is added to the process reference map.

Since, in Step 920 of FIG. 9, all edges representing outbound references and their reciprocal edges representing inbound references have been removed, the remaining dependency graph only has inbound references without reciprocal edges. Therefore for each edge, an inconsistency is reported in Step 1140 and the edge is removed in Step 1150.

After performing Step 1150, the method may proceed to Step 1160 to determine if the current node is the last node. If the current node is the last node, then the method ends at Step 1170. On the other hand, if there are additional nodes remaining, then the method proceeds to Step 1110 to begin inspecting the next node.

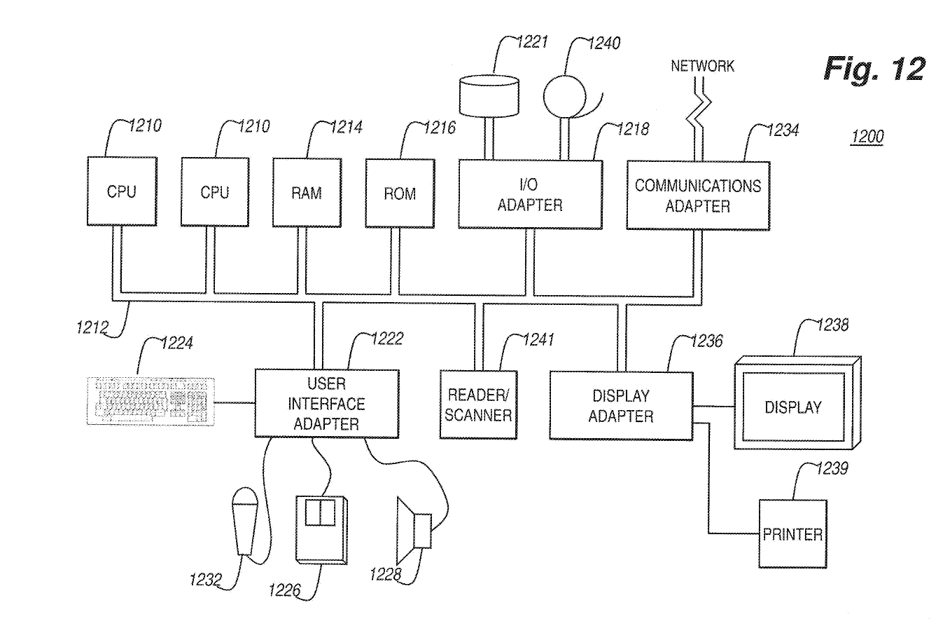

Referring now to FIG. 12, system 1200 illustrates a typical hardware configuration which may be used for implementing the inventive system and method. The configuration has preferably at least one processor or central processing unit (CPU) 1210. The CPUs 1202 are interconnected via a system bus 1212 to a random access memory (RAM) 1214, read-only memory (ROM) 1216, input/output (1/0) adapter 1218 (for connecting peripheral devices such as disk units 1221 and tape drives 1240 to the bus 1212), user interface adapter 1222 (for connecting a keyboard 1224, mouse 1226, speaker 1228, microphone 1232, and/or other user interface device to the bus 1212), a communication adapter 1234 for connecting an information handling system to a data processing network, the Internet, and Intranet, a personal area network (PAN), etc., and a display adapter 1236 for connecting the bus 1212 to a display device 1238 and/or printer 1239. Further, an automated reader/scanner 1241 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Such a method may be implemented, for example, by operating the CPU 1210 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 1210 and hardware above, to perform the method of the invention.

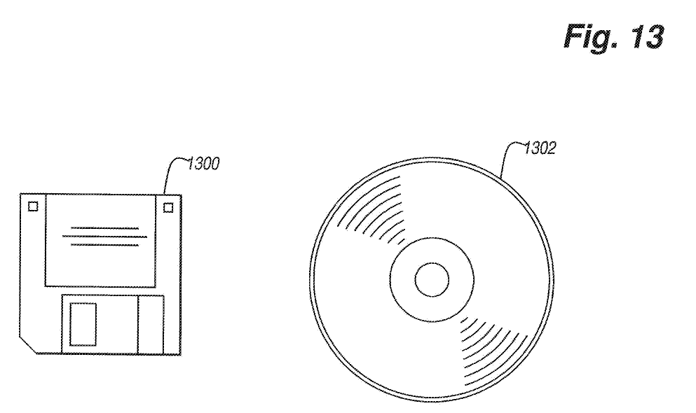

This signal-bearing media may include, for example, a RAM contained within the CPU 1210, as represented by the fast-access storage for example. Alternatively, the instructions may be contained in another signal-bearing media, such as a magnetic data storage diskette 1300 or CD-ROM 1302, (FIG. 13), directly or indirectly accessible by the CPU 1210.

Whether contained in the computer server/CPU 1210, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

1. A computerized method of constructing a process reference map, the method comprising:
iterating, as executed in a processor, over each of a plurality of process models;
creating, as executed in the processor, an intermediary reference graph;
adding, as executed in the processor, a directed link for each reference in the process models to the intermediary reference graph, the link pointing from a node in the reference graph representing a process model within which a reference occurred to a node representing a process model that the reference is pointing towards;
determining, as executed in the processor, between two process models of the plurality of process models, whether an inconsistency including one of an outbound process reference missing inconsistency, an inbound process reference missing inconsistency, and an unavailable information inconsistency exists; and
constructing, as executed in the processor, a new process model map from the intermediary reference graph with one element each representing a process model and the elements being linked representing the references therebetweeen and storing said new process model map in a memory associated with said processor,
wherein each link comprises an attribute indicating one of a context, a type of reference, and a modeling element.
